(19) United States
(12) Patent Application Publication
(10) Pub. No.: US 2012/0133679 A1
(43) Pub. Date: May 31, 2012

(54) SERVER, CLIENT, IMAGE ACQUISITION METHOD

(75) Inventors: Takahide Kubota, Izunokuni-shi (JP); Masanori Sambe, Mishima-shi (JP); Takashi Makiyama, Tokyo (JP)

(73) Assignee: TOSHIBA TEC KABUSHIKI KAISHA, Tokyo (JP)

(21) Appl. No.: 13/282,615

(22) Filed: Oct. 27, 2011

(30) Foreign Application Priority Data
Nov. 25, 2010 (JP) 2010-262339

(51) Int. Cl. G09G 5/00

(52) U.S. Cl. 345/660

(57) ABSTRACT

According to one embodiment, a client apparatus, includes an image acquisition unit, a use reception unit, an image size detection unit, a size change unit and a sending unit. The image acquisition unit acquire an image file from externally. The use reception unit receipt a selection of a use for the image file from various image-related uses. The image size detection unit detect the size information of an image corresponding to the use selected by the use reception unit from various size information and respectively corresponding to images for the various uses. The size change unit change the size of the image data stored in the image file acquired by the image acquisition unit to the size. The sending unit upload the image file in which the image data the size of which is changed by the size changing unit is stored to a server.

### CROSS-REFERENCE TO RELATED APPLICATION

This application is based upon and claims priority from prior Japanese Patent Application No. 2010-262339, filed on Nov. 25, 2010, the entire contents of which are incorporated herein by reference.

### FIELD

Embodiments described herein relate generally to a client which is used for acquiring an image file from a storage medium and a server which is used for storing the image file acquired by the client.

### BACKGROUND

There has been an image acquisition system in which an image file acquired by a client is stored in a server that is connected with the client via a network. In existing image acquisition system, a client uploads an image file acquired from a storage medium to a server without making a change in data size. The server sends the client-uploaded image file to an image processing terminal without making a change in data size. The image processing terminal changes the data size of the image file received from the server to a use-corresponding size and generates an image, which is displayed on the display of the image processing terminal. This image processing terminal corresponds with, for example, an electronic menu terminal used in restaurants which displays images of various menus as one overall menu image.

Before acquired by a client, an image file is generally large in data size. Therefore, the image file sent or received between a client and a server has a large data size, thus leading to a high network load between the client and the server. Moreover, the resource of the image processing terminal is greatly consumed due to the performance of an image data size change.

### DESCRIPTION OF THE DRAWINGS

FIG. 1 is a diagram illustrating the structure of an image acquisition system;

FIG. 2 is a diagram illustrating an example of the conversion of a screen displayed on the display of an electronic menu terminal;

FIG. 3 is a block diagram illustrating the structures of the main components of a client;

FIG. 4 is a diagram illustrating the structure of a piece of software installed on a client;

FIG. 5 is a block diagram illustrating the structures of the main components of a server;

FIG. 6 is a diagram illustrating the configuration of an image acquisition program downloaded from a server to a client;

FIG. 7 is a flow chart illustrating the main unit of an assistant image acquisition executed by the CPU of a server;

FIG. 8 is a flow chart illustrating a process of an image file acquisition controlled by an image acquisition program; and

FIG. 9 is a flow chart illustrating another process of the image file acquisition controlled by the image acquisition program.

### DETAILED DESCRIPTION

In general, according to one embodiment, a client apparatus includes an image acquisition unit, a use reception unit, an image size detection unit, a size changing unit and a sending unit.

The image acquisition unit acquires an image file. The use reception unit receives a selection of the image file use from various image-related uses. The image size detection unit detects the size information of an image corresponding to the use selected by the use reception unit from various size information that is input into an image acquisition program and respectively corresponding to images for the various uses. The size changing unit changes the size of the image data stored in the image file acquired by the image acquisition unit to the size detected by the image size detection unit. The sending unit uploads the image file in which the size-changed image data is stored to a server.

According to another embodiment, the server includes a downloading unit and an image storage unit. The downloading unit downloads an image acquisition program for a client connected with a network. The image storage unit stores the image file that is uploaded by the client via the network.

Several embodiments of an image acquisition system comprising the above-described client and server are described below with reference to accompanying drawings. These embodiments illustrate the acquisition of an image file to be displayed on an electronic menu terminal from a storage medium. The uses of an image file comprise, for example, a first use for displaying a category with a category selection screen, a second use for displaying a menu with a menu selection screen, and a third use for displaying an order-accepted commodity with an order confirmation screen.

### Embodiment 1

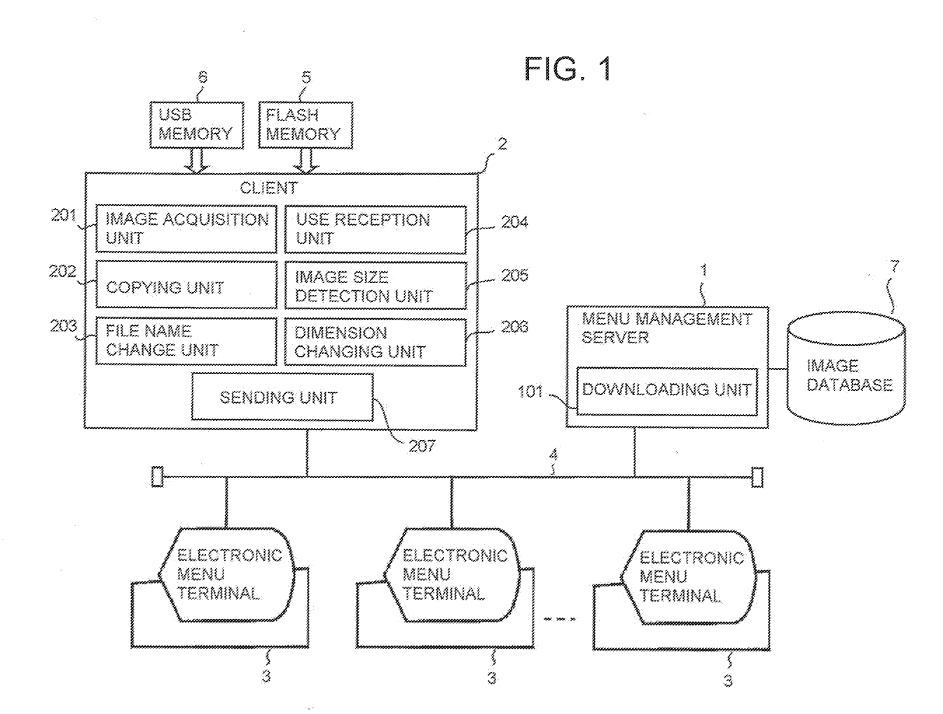

FIG. 1 is a diagram illustrating the structure of an image acquisition system. This system includes a server 1, a client 2 and a plurality of electronic menu terminals 3. The server 1 is connected with the client 2 and each electronic menu terminal 3 via a network 4 such as the Internet. The electronic menu terminal 3 is a form of an image processing terminal. Besides, in this embodiment, the network connecting the server 1 with the client 2 is the same as that the network connecting the server 1 with each electronic menu terminal 3. These network can be in different types.

The client 2 acquires image data from a storage medium such as a flash 5 or a USB (universal serial bus) memory 6 and the like in a file format such as JPEG, TIF and BMP and the like. The client 2 uploads the acquired image file to the server 1 via the network 4. In order to achieve the actions above, the client 2 comprises an image acquisition unit 201, a copying unit 202, a file name changing unit 203, a use reception unit 204, an image size detection unit 205, a size changing unit 206 and a sending unit 207.

The server 1 stores the image file uploaded by the client 2 in an image database 7 that serves as an image storage unit. The server 1 sends the image file stored in the image database 7 to each electronic menu terminal 3 via the network 4. In order to achieve the actions above, the server comprises a downloading unit 101.

Each electronic menu terminal 3 is installed with an application program for generating various images with the image data of the image file sent by the server 1. This program may be installed in each electronic menu terminal 3 in advance or downloaded into each electronic menu terminal 3 from the server 1 via the network 4.

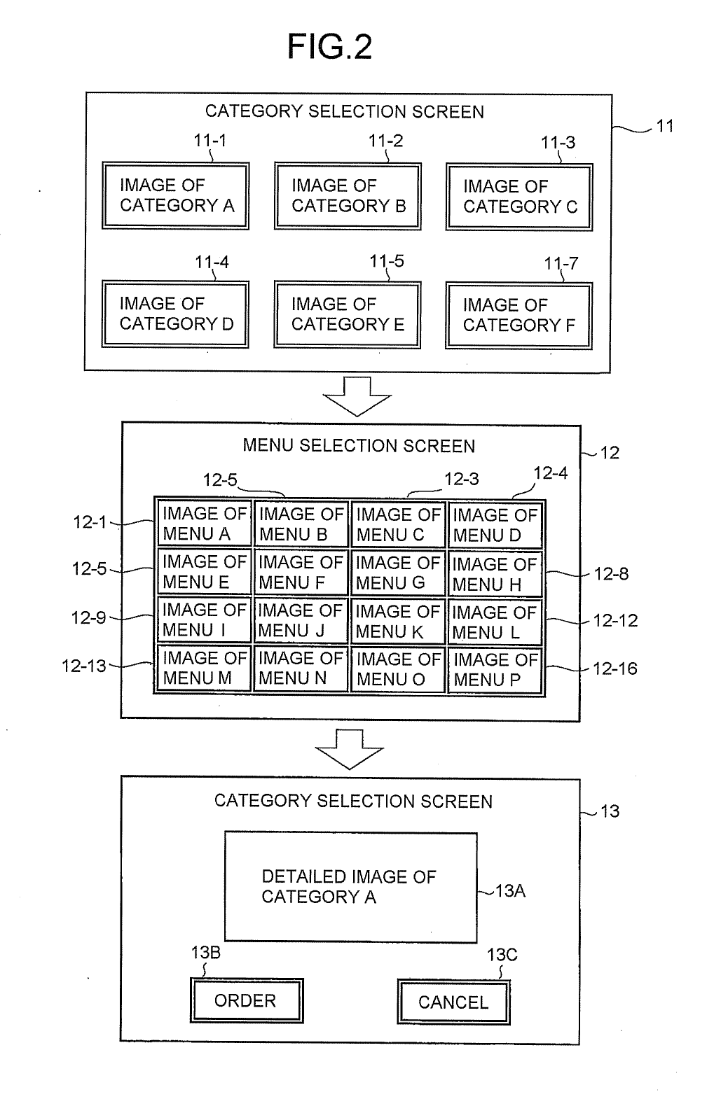

FIG. 2 is a diagram illustrating an example of the conversion of a screen displayed on the electronic menu terminal 3. In FIG. 2, screen 11 is a category selection screen displaying various menu categories. Screen 12 is a menu selection screen displaying various menus of the same category. Screen 13 is an order confirmation screen displaying the detailed image of a menu selected from the menu selection screen 12. Moreover, the layout of screens 11, 12 and 13 shown in FIG. 2 is just an example and should not be construed as a limitation. In addition, the screens displayed on the electronic menu terminal 3 are not limited to screens 11, 12 and 13.

In the category selection screen 11, each category is displayed in a button form. The image of the representative menu of a category is displayed on the button 11-i (i=1, 2, 3, . . . , 6) of the category. If an optional category button 11-i is selected by operating an input device, the screen is switched to the menu selection screen 12 from the category selection screen 11. The input device refers to a keyboard, a mouse, a touch screen and the like.

The various menu items belonging to the category selected by the category selection screen 11 are displayed in the menu selection screen 12 in a button form. The image of a menu item is displayed in the button 12-j (j=1, 2, 3, . . . , 16) of each menu item. If an optional menu button 12-j is selected by operating the input device, the screen is switched to the order confirmation screen 13 from the menu selection screen 12.

A detailed image 13A of the menu item selected in the menu selection screen 12 is displayed in the order confirmation screen 13. An order button 13B and a cancel button 13C are displayed in the order confirmation screen 13. An order for the menu item the detailed image 13 A of which is displayed is confirmed when the order button 13 B is input by operating the input device. Correspondingly, the order for the menu item is cancelled if the cancel button 13c is input. The screen is returned to the category selection screen 11 from the order confirmation screen 13 if the order button 13B or the cancel button 13C is input.

By comparing the data sizes of the images displayed on the screens 11, 12 and 13, it can be seen that the image of the menu item displayed on each menu button 12-j of the menu selection screen 12 is smallest while the detailed image 13A displayed on the order confirmation screen 13 is largest. For instance, the image displayed on the menu selection screen 12 is 160×120 pixels, the image displayed on the category selection screen 11 is 400×300 pixels, and the detailed image 13A displayed on the order confirmation screen 13 is 800×600 pixels.

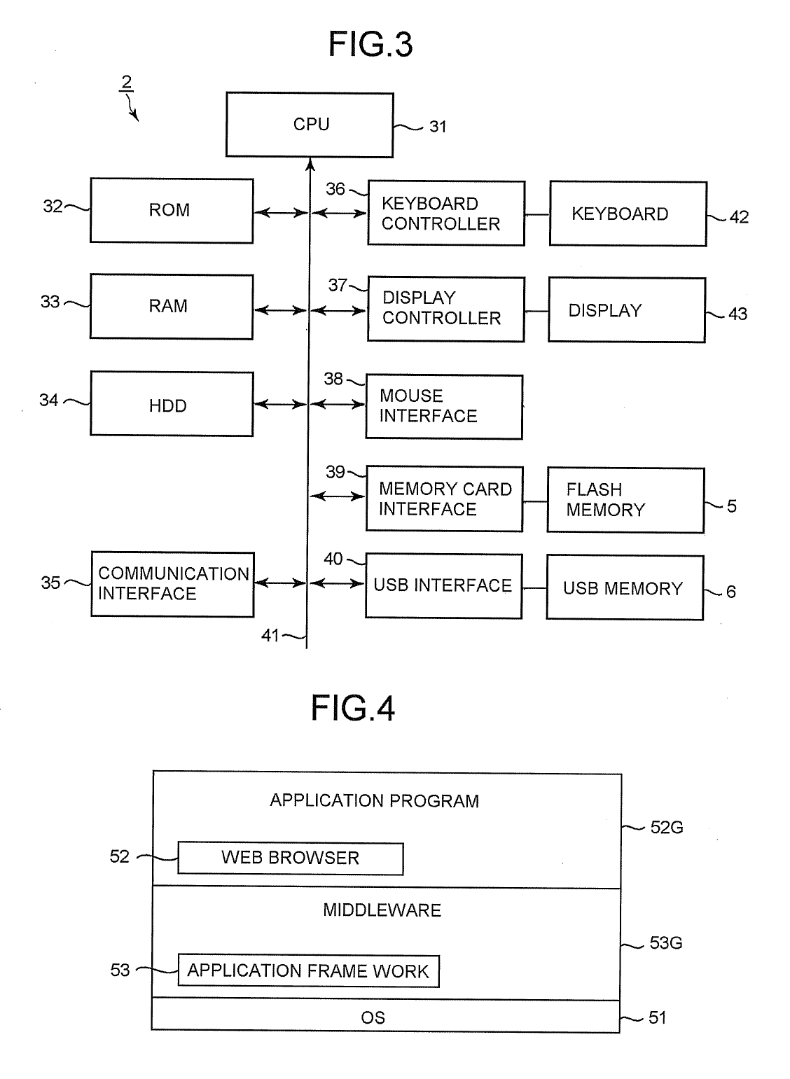

FIG. 3 is a block diagram illustrating the structures of the main components of the client 2. The client 2 carries a CPU 31, a read only memory (ROM) 32, a random access memory (RAM) 33, a hard disk drive (HDD) 34, a communication interface 35, a keyboard controller 36, a display controller 37, a mouse interface 38, a memory card interface 39 and a USB interface 40. The CPU 31 is connected with the other components 32-40 via a bus line 41 such as an address bus, a data bus and the like.

The CPU 31 controls each component 32-40 for achieving actions of the client 2 by an operating system, a middleware or an application program.

The ROM 32 store the operating system. The ROM 32 may also be used to store the middleware or application program. Additionally, the ROM 32 may also to used store the reference data for the CPU 31 to perform various processing.

The RAM 33 store the reference data that is used for the CPU 31 to control the components 32-35. The RAM 33 is used as a region (a so-called working region) for storing the data that is temporarily used by the CPU 31 to control the components 32-40. Additionally, the RAM 33 may also be used to store the middleware or application in some cases.

The HDD 34 is used for storing the data used by the CPU 31 to control the components 32-40 or the data resulting from the control of the CPU 31. Additionally, the HDD 34 may also be used to store the middleware or application program.

The communication interface 35 controls a data communication carried out between the servers 1 that are connected with each other through a network 4. The keyboard controller 36 controls a keyboard 42 that serves as an input device. The control display 37 controls the image display of the display 43 serving as a display device. The mouse interface 38 is electrically connected with a mouse serving as an input device.

The memory card interface 39 reads data from or writes data into the flash 5. The USB interface 40 reads data from or writes data into the USB memory 6.

FIG. 4 is a diagram illustrating the structure of a piece of software installed on the client 2. The client 2 forms a piece of software with an operating system (OS) 51, a plurality of applications (APL) programs 52G comprising a web browser 52 and a plurality of pieces of middleware 53G comprising an application frame 53.

The web browser 52 refers to a piece of software for browsing a website on the Internet. The application frame 53, which is provided as a plug-in component of the web browser 52, is used for regenerating or dynamically processing an image on the web browser 52. Such application frame comprises, for example, Silverlight (trademark).

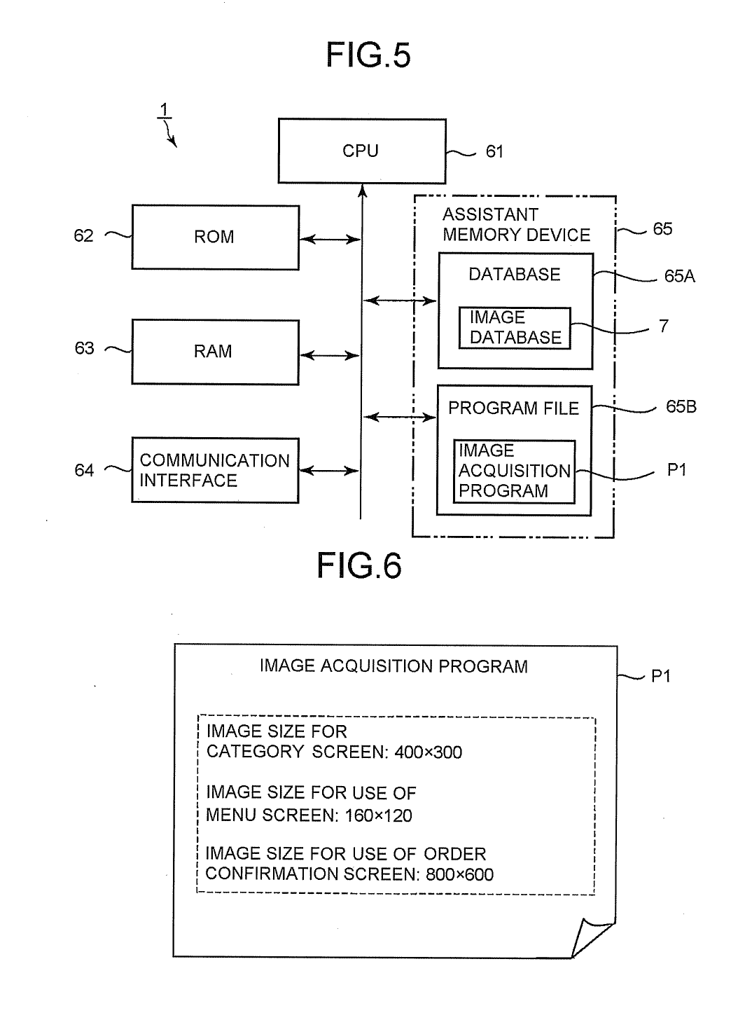

FIG. 5 is a block diagram illustrating the structures of the main components of the server 1. The server 1 carries a CPU 61, an ROM 62, an RAM 63, a communication interface 64 and an assistant memory 65. The CPU 61 is connected with other components 62-65 via a bus line 66 such as an address bus, a data bus and the like.

The CPU 61 controls the other components 62-65 for achieving actions of the server 1 by an operating system, a piece of middleware or an application program.

The ROM 62 store the operating system. The ROM 62 may also be used to store the middleware or application program. Additionally, The ROM 62 may also be used to store the reference data for the CPU 61 to perform various processing.

The RAM 63 store the reference data that is used for the CPU 61 to control the components 62-65. Additionally, the RAM 63 is used as a region (a so-called working region) for storing the data that is temporarily used by the CPU 61 to control the components 62-65. Additionally, the RAM 63 may also be used to store the middleware or application program.

The communication interface 64 controls a data communication carried out between the client 2 and each electronic menu terminal 3 that are connected with each other through a network 4.

The assistance memory 65 is provided with a database region 65A for storing various databases including the image database 7 and a program region 65B for storing various applications including an image acquisition program P1. An HDD or a solid state drive (SDD) serves as the assistant memory 65.

The image acquisition program P1 controls the image file acquisition carried out in the client 2. The image acquisition program P1 as shown in FIG. 6, input an image size data for the uses of a category screen, a menu screen and an order confirmation screen. The image size of the use of a category screen refers to the data size (e.g. 400*300 pixels) of an image file used in the category selection screen 11. The image size for the use of a menu screen refers to the data size (e.g. 160*120 pixels) of an image file used in the category selection screen 12. The image size for the use of an order confirmation screen refers to the data size (e.g. 800*600 pixels) of an image file used in the order confirmation screen 13.

The server 1 assists the client 2 in acquiring an image file by providing the client 2 a basic network application program (referring here to the image acquisition program P1) through software as a service (SaaS).

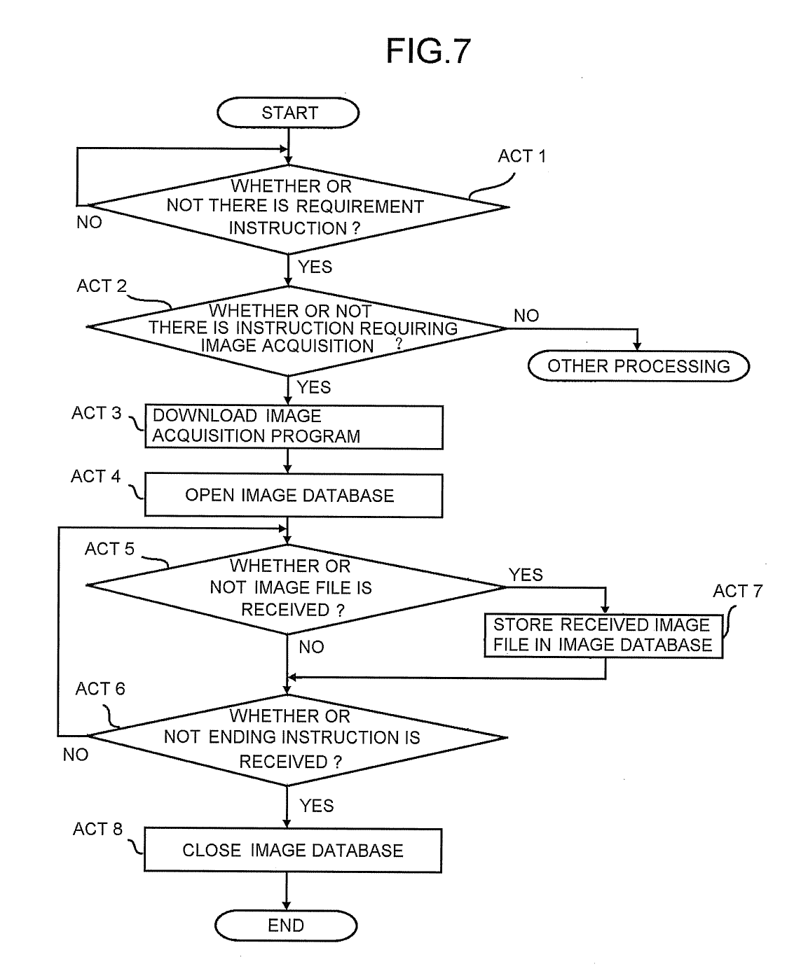

FIG. 7 is a flow chart illustrating the major process of an assistant image acquisition processing executed by the CPU 61 of the server 1. The CPU 61 determines whether or not there is a requirement instruction sent from the client 2 (Act 1). If there is no requirement instruction sent from the client 2 (Act 1: No), keeps waiting until there is a requirement instruction sent from the client 2.

If receiving a requirement instruction from the client 2 via the network 4 (Act 1: Yes), the CPU 61 determines whether or not the instruction requires an image acquisition (Act 2). If the instruction requires no image acquisition (Act 2: No), the CPU 61 executes a processing in response to what the instruction is required.

If receiving an instruction requiring an image acquisition from the client 2 via the network 4 (Act 2: Yes), the CPU 61 reads the image acquisition program P1 from the program file region 65B. And the CPU 61 activates the downloading unit 101 to download the image acquisition program P1 into the client 2 via the network 4 (Act 3).

The CPU 61 opens the image database 7 stored in the database region 65A (Act 4). And the CPU 61 determines whether or not an image file is received (Act 5). If is in the case where no image file is received (Act 5: No), the CPU 61 determines whether or not an ending instruction is received (Act 6: No). If is in the case where no ending instruction is received (Act 6: No), the CPU 61 waits to receive an image file or ending instruction.

After receiving an image file from the client 2 via the network 4 (Act 5: Yes), the CPU 61 stores the received image file in the image database 7 (Act 7).

After receiving an ending instruction from the client 2 via the network 4 (Act 6: Yes), the CPU 61 closes the image database 7 (Act 8). Then the CPU 61 ends the current assistant image acquisition processing.

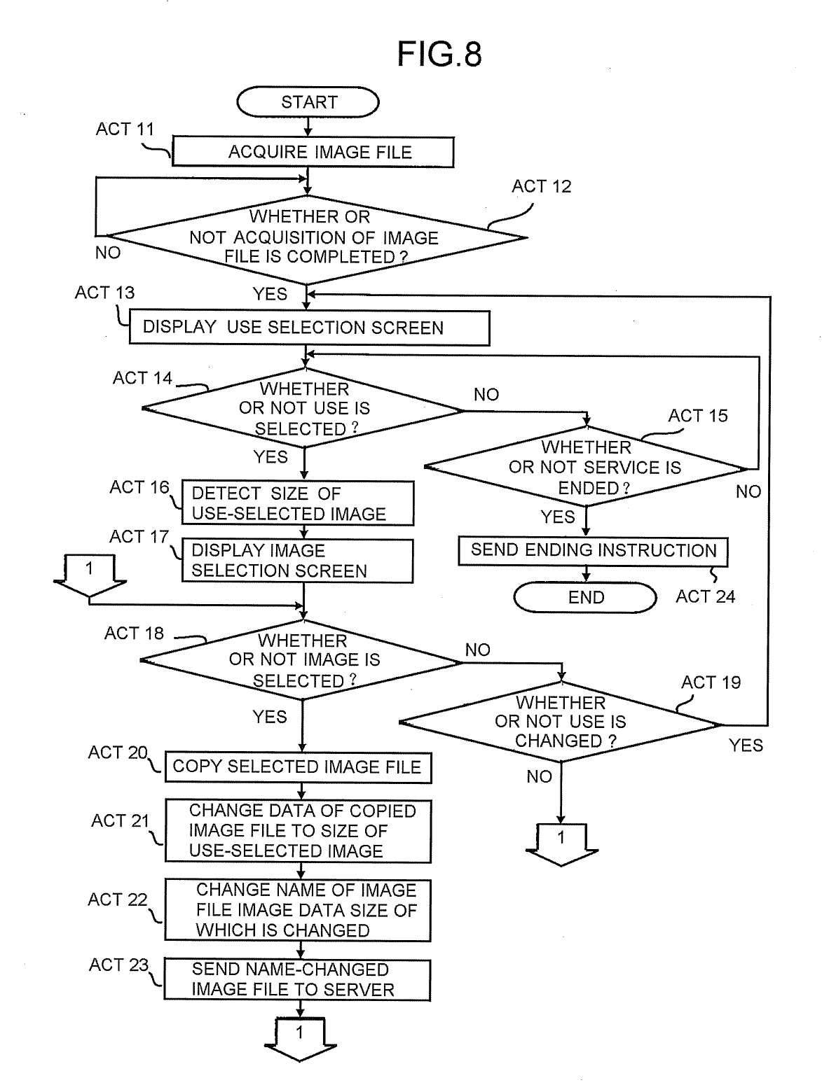

FIG. 8 is a flow chart illustrating the major process of an image file acquisition processing controlled by the image acquisition program P1. The user of the client 2 operates, for example, the key board 42 to start the acquisition of an image file. The CPU 31 of the client 2 sends an instruction requiring an image acquisition to the server 1 via the network 4. In accordance with the instruction, the image acquisition program P1 is downloaded from the server 1. Then the CPU 31 of the client 2 activate the image acquisition program 21 which downloaded.

If the image acquisition program P1 activate, the CPU 31 starts a process of the flow shown in FIG. 8. First, the CPU 31 acquires an image file from a storage medium (Act 11). For example, if the flash 5 is connected with the memory card interface 39, the CPU 31 acquires an image file from a flash 5. If the USB memory 6 is connected with the memory card interface 39, the CPU 31 acquires an image file from a USB memory 6. In this way, the image acquisition program P1 enables the client 2 to realize the external image file acquisition function of the image acquisition unit 201.

The CPU 31 determines whether or not the acquisition of the image file is completed (Act: 12). If is in the case where the acquisition of the image file is not completed (Act 12: No), the CPU 31 waits until the acquisition is completed.

If is in the case where the acquisition of the image file is completed (Act 12: Yes), the CPU 31 displays a use selection screen on the display 43 (Act 13). On the use selection screen is displayed the information for the user to select a use for the image file acquired from the storage medium. The uses of an image file includes a first use for displaying a category with a category selection screen, a second use for displaying a menu with a menu selection screen, and a third use for displaying an order-accepted commodity with an order confirmation screen. In this way, the image acquisition program P1 enables the client 2 to realize the function of the use reception unit 204 for selecting a use for the image file from various image-related uses.

The CPU 31 determines whether or not a use is selected (Act 14). If no use is selected (Act 14: No), the CPU 31 determines whether or not the service is declared ended (Act 15). If there is no declaring of a service ending (Act 15: No), the CPU 31 waits for the declaring of a use selection or a service ending.

If any one of the uses 1-3 is selected by operating, for example, the keyboard 42 (Act 14: Yes), the CPU 31 detects from the image acquisition program P1, the size information (A*B pixels) of the image the use of which is selected (Act 16). The detected size information is stored in the working region of the RAM 33. In this way, the image acquisition program P1 enables the client to realize the function of the image size detection unit 205 for detecting the size information of an image corresponding to the use selected by the use reception unit 204 from various size information that is input into an image acquisition program P1 and respectively corresponding to images for various uses.

The CPU 31 displays an image selection screen on the display 43 (Act 17). On which the images of all the image files acquired from the storage medium through the Act 11 are displayed in the form of thumbnail.

The CPU 31 determines whether or not an image is selected (Act 18). If is in the case where no image is selected (Act 18: No), the CPU 31 determines whether or not a use change is declared (Act 19). If there is no use change declared (Act 19: No), the CPU 31 waits for an image selection or the declaring of a use change.

If any thumbnail is selected by operating the keyboard 42 (Act 18: Yes), for example, the CPU 31 copies the image file in which the selected image data is stored into the working region of the RAM 33 (Act 20). The CPU 31 changes the image data of the copied image file to the image size data detected through the Act 16 (21). In this way, the image acquisition program P1 enables the client 2 to realize the function of the copying unit 202 for copying the image file acquired by the image acquisition unit 201 and the function of the size changing unit 206 for changing the size of the image data in the image file copied by the copying unit 202 to the size detected by the image detection 205.

The CPU 31 changes the name of the image file changed in image data size to a fixed name corresponding to the use selected by the Act 14 (Act 22). For instance, the CPU 31 changes the name of the image file changed in image data size to a name ‘category-n’ if the first use of displaying each category with a category selection screen 11 is selected, a name ‘menu-n’ if the second use of displaying each menu with a menu selection screen 12 is selected, or a name ‘order-n’ if the third use of displaying an order-accepted commodity with an order confirmation screen 13 is selected. In addition, the subscript n of the file name is a number that is progressively increased from 1. In this way, the image acquisition program P1 enables the client 2 to realize the function of the file name changing unit 203 for changing the name of the image file copied by the copying unit 202 to a name corresponding to the use selected by the use reception unit 204.

The CPU 31 sends the name-changed image file to the server 1 via the network 4 (Act 23). In this way, the image acquisition program P1 enables the client 2 to realize the function of the sending unit 207 for uploading the image file in which the image size data changed by the size changing unit 206 is stored to a screen management server 1.

Sequentially, the CPU 31 determines whether a next image is selected from the image selection screen (Act 18). The CPU 31 executes the above-described Act 20-Act 30 if a next image is selected (Act 18: Yes).

The CPU 31 returns the screen displayed on the display 43 to the use selection screen (Act 13). The CPU 31 waits for a use selection (Act 14) or declares the service is ended (Act 15) if no image is selected (Act 18: No) and a use change is declared (Act 19: Yes).

At this time, if a service ending is declared by operating the keyboard 42 (Act 15: Yes), the CPU 31 sends an ending instruction to the server 1 via the network 4 (Act 24). Then, the image acquisition program 21 is end.

It is assumed presently that the image data of the image file stored in the storage medium of the flash 5 or the USB memory 6 is the data on the menu items photographed by a digital camera with a high resolution of 1600*1200 pixels, and that the image displayed on the menu selection screen 12 is 160×120 pixels, the image displayed on the category selection screen 11 is 400×300 pixels, and the detailed image 13A displayed on the order confirmation screen 13 is 800×600 pixels, as shown in FIG. 6.

Then, an image file stored in the storage medium is acquired into the client 2 once the user of the client 2 starts the acquisition of the image file, and a use selection screen is displayed on the display of the client 2.

Here, if the user selects the first use of displaying each category with a category selection screen 11, the screen displayed on the display is switched to an image selection screen. And the user selects the image of the menu used in the category selection screen 11. Then, the image file of the selected image is copied in the client 2, with its image data size decreased from 1600*1200 pixels to 400*300 pixels and its file name changed to be ‘category-1’. Moreover, the image file named ‘category-1’ is uploaded to the server 1 and stored in the image database 7.

Then, the same processing is executed in the client 2 if the image of another menu used in the category selection screen 11 is selected by the user. And the image file that is named ‘category-1’ and decreased to an image data size of 400*300 pixels is stored and then uploaded to the server 1 and stored in the image database 7.

Thereafter, the same processing is executed in the client 2 every time the user selects a menu item. After completing the selection on the images used in the category selection screen 11, the user declares a use change. Then, as the screen displayed on the display 43 is returned to the use selection screen, the user proceeds to select the second use of displaying each menu with the menu selection screen 12. As the screen displayed on the display is switched to the image selection screen, the user selects the image of a menu used in the menu selection screen 12. Then, the image file of the selected image is copied in the client 2, with its image data size decreased from 1600*1200 pixels to 160*120 pixels and its file name changed to be ‘menu-1’. Moreover, the image file named ‘menu-1’ is uploaded to the server 1 and stored in the image database 7.

Then, the same processing is executed in the client 2 if the image of another menu used in the menu selection screen 12 is selected by the user. And an image file that is named ‘menu-2’ and decreased to an image data size of 160*120 pixels is stored and then uploaded to the server 1 and stored in the image database 7.

Thereafter, the same processing is executed in the client 2 every time the user selects a menu item. After completing the selection on the images used in the menu selection screen 12, the user declares a use change again. Then, as the screen displayed on the display 43 is returned to the use selection screen, the user proceeds to select the third use of displaying an order-accepted menu with the order confirmation screen 13. Then, as the screen displayed on the display is switched to the image selection screen, the user selects the image of a menu item used in the order confirmation screen 13. Then, the image file of the selected image is copied in the client 2, with its image data size decreased from 1600*1200 pixels to 800*600 pixels and its file name changed to be ‘order-1’. Moreover, the image file named ‘order-1’ is uploaded to the server 1 and stored in the image database 7.

Then, the same processing is executed in the client 2 when the image of another menu item used in the order confirmation screen 13 is selected by the user, and an image file that is named ‘order-2’ and decreased to an image data size of 800*600 pixels is stored and then uploaded to the server 1 and stored in the image database 7.

Thereafter, the same processing is executed in the client 2 every time the user selects a menu item. After completing the selection on the images used in the menu selection screen 13, the user declares a service ending.

Then, in the image database 7 of the server 1, there is an image file named ‘category-n’, in which a menu image of 400*300 pixels is stored, an image file named ‘menu-n’, in which a menu image of 160*120 pixels is stored, and an image file named ‘order-n’, in which a menu image of 400*300 pixels is stored.

The image files are sent, via the network 4, to each electronic menu terminal 3. In the electronic menu terminal 3, a category selection screen 11 is generated according to the image data of the menu stored in the image file named ‘category-n’, a menu selection screen 12 is generated according to the image data of the menu stored in the image file named ‘menu-n’, and an order confirmation screen 13 is generated according to the image data of the menu stored in the image file named ‘order-n’.

In this way, the client 2 reduces the high-resolution image data acquired from the storage medium 5 or 6 to low-resolution image data corresponding to an optionally selected use and then uploads the low-resolution image data to the server 1. On the other hand, the server 1 stores the low-resolution image data received from the client 2 in the image database 7 and sends, as needed, the low-resolution image data to each electronic menu terminal 3. Therefore, the loads of the network between the client 2 and the server 1 and the network between the server 1 and each electronic menu terminal 3 are reduced. Besides, as each electronic menu terminal 3 do no need to change the size of the image data received from the server 1, high resource consumption is avoided.

### Embodiment 2

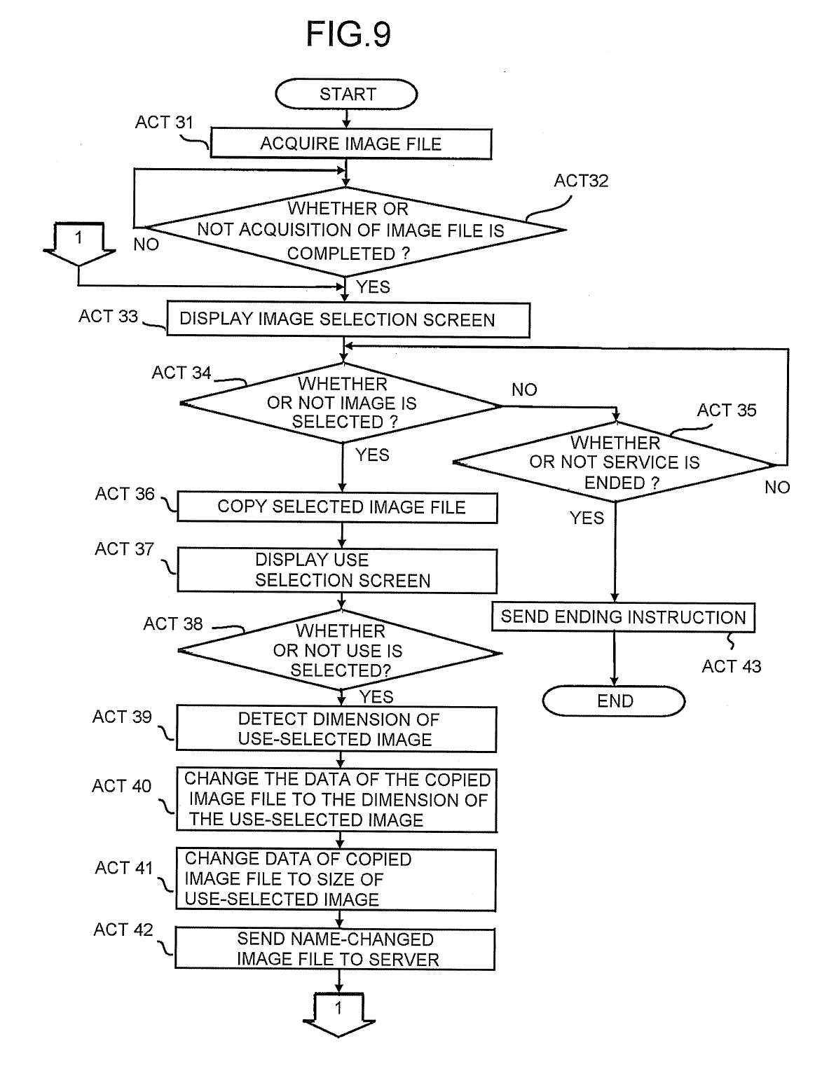

Embodiment 2 is partially different from the image file acquisition controlled by the image acquisition program P1. FIG. 9 is a flow chart illustrating the major process of an image file acquisition realized in embodiment 2.

As shown in FIG. 9, a CPU 31 acquires an image file from a storage medium if an image acquisition program 21 is activated (Act 31: an image acquisition unit 201). The CPU 31 displays an image selection screen if the acquisition of the image file is completed (Act 32: Yes) (Act 33). The CPI 31 determines whether or not an image is selected (Act 34). The CPI 31 determines whether or not the service is declared ended in the case if no image is selected (Act 34: No) (Act 35). The CPI 31 waits for an image selection or the declaring of a service ending if there is no declaring of a service ending (Act 35: No).

If any thumbnail is selected by operating, for example, the keyboard 42 (Act 34: Yes), the CPU 31 copies the image file in which the selected image data is stored into the working region of the RAM 33 (Act 36: a copying unit 202).

Then, the CPU 31 displays a use selection screen on the display 43 (Act 37: a use reception unit 204). The CPI 31 determines whether or not a use is selected (Act 38). The CPU 31 waits until a use is completed if no use is selected (Act 38: No).

If any use is selected by operating, for example, the keyboard 42 (Act 38: Yes), the CPU 31 detects from the image acquisition program P1 the size information (A*B pixels) of the image the use of which is selected (Act 39: an image size detection unit 205).

Then, the CPU 31 changes the image data of the image file copied through the Act 36 to the image size data detected through the Act 39 (Act 40: a size changing unit 206). And the CPU 31 changes the name of the image file changed in image data size to a fixed name corresponding to the use selected through the Act 38 (Act 41: a file name changing unit 203). In suitable timing the CPU 31 sends the name-changed image file to the server 1 via the network 4 (Act 42: a sending unit 207).

After sending the image file, the CPU 31 changes the screen displayed on the display 43 to the image selection screen and waits for an image selection (Act 34) or the declares of a service ending (Act 35).

In selecting an image, the CPU 31 repeats the Act 36-42. Oppositely, if the service is declared ended (Act 35: Yes), the CPU 31 sends an ending instruction to the server 1 via the network 4 (Act 43). Then, the image acquisition P1 is ended.

In embodiment 1, after selecting a use from a use selection screen, the user of the client 2 selects an image for the selected use from an image selection screen, therefore if many menu thumbnails displayed on the image selection screen, it take the user a lot of time to select from these menu thumbnails.

On the contrary, in embodiment 2, after selecting a desired thumbnail from the image selection screen, a user can select a use for the selected thumbnail. Therefore, for example, images can be sequentially selected from the image selection screen, so it is not trouble to find a desired image.

In addition, it is apparent that in embodiment 2, the load of the network 4 is reduced, and the resource consumption is low in each electronic menu terminal 3.

Other embodiments are briefly described below.

Although the image acquisition program P1 is always downloaded by the server 1 for the client 2 in the aforementioned embodiments, the present invention is not limited to this mode. For instance, before the Act 3 shown in FIG. 7 is executed, the CPU 61 of the server 1 compare a version of the latest image acquisition program that is downloaded in the client 2 with a version of the image acquisition program that is currently stored in the program file region 65B. Then, if version up is detected, may download an updated image acquisition program.

Moreover, components that enable storage mediums to have the same storage function may be installed on the client 2. The storage medium refers to a disc, an ROM, a memory or any other storage medium that can be used to store programs and is readable to a device and can be in any form. Moreover, the functions achieved through a pre-installation or download can also be achieved through a cooperation with an operating system (OS) installed inside a device.

Although in the aforementioned embodiments, image data is acquired by the client 2 from a storage medium such as the flash 5 or USB memory 6, the present invention is not limited to such an acquisition, the client 2 may also acquire image data from the outside.

In aforementioned embodiments, the client 2 uploads, one by one, the image files that are changed in data size to the server 1. However, the present invention is not limited to such an upload. For instance, the Act 23 shown in FIG. 8 or the Act 42 shown in FIG. 9 may be omitted. Moreover, when the service is declared ended through the Act 15 or Act 35, the CPU 31 uploads the image file copied in a working memory to the server 1, and then sends an ending instruction to the server 1 via the network 4. Thus, the client 2 may uniformly upload the image files that are changed in data size to the server 1.

In the aforementioned embodiments, the electronic menu terminal 3 is illustrated as a form of an image processing terminal, which is, however, not limited to be the electronic menu terminal 3, and may be a kitchen terminal, a POS terminal, a hand-hold terminal for the input of an order and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A client apparatus, comprising:
an image acquisition unit configure to acquire an image file from externally;
a use reception unit configure to receipt a selection of a use for the image file from various image-related uses;
an image size detection unit configure to detect the size information of an image corresponding to the use selected by the use reception unit from various size information that is input into an image acquisition program and respectively corresponding to images for the various uses;
a size change unit configure to change the size of the image data stored in the image file acquired by the image acquisition unit to the size detected by the image size detection unit; and
a sending unit configure to upload the image file in which the image data the size of which is changed by the size changing unit is stored to a server.

2. The apparatus according to claim 1, further comprising:
a copying unit configure to copy the image file acquired by the image acquisition unit, wherein
the size change unit changes the size of the image data stored in the image file copied by the copying unit to the size detected by the image size detection unit.

3. The apparatus according to claim 2, further comprising:
a file name change unit configure to change the name of the image file copied by the copying unit to a name corresponding to the use selected by the use reception unit.

4. The apparatus according to claim 1, wherein
the use reception unit selects at least one of the category selection screen, the menu selection screen and the order confirmation screen displayed on an electronic menu terminal as a selectable use.

5. A server apparatus comprising:
a downloading unit configure to download an image acquisition program for a client connected with a network; and
an image storage unit configure to store the image file that is uploaded by the client via the network, wherein
the image acquisition program enables the client to execute a function of acquiring an image file from external a function of selection a use for the image file from various image-related uses, a function of detection the size information of an image corresponding to the selected use from various size information that is input into the image acquisition program and respectively corresponding to images for various uses, a function of change the size of the image data stored in the externally-acquired image file to the detected size, and a function of uploading the image file in which the size-changed image data is stored to the server via the network.

6. The apparatus according to claim 5, wherein
the image acquisition program further enables for client to execute a function of copy the image file acquired from external;
the function of change the size changes the image data of the copied image file to the image data with the size detected from the image acquisition program.

7. The apparatus according to claim 5, wherein
the image acquisition program enables the client to acquire an image file using an application frame work provided as a plug-in component of as a website browser installed on the client.

8. A method for a client to acquire an image, comprising:
an image acquisition unit for externally acquiring an image file;
acquiring an image file from externally by an image acquisition unit;
receiving a selection of a use for the image file from various image-related uses by a use reception unit;
detecting the size information of an image corresponding to the use selected by the use reception unit from various size information that is input into an image acquisition program and respectively corresponding to images for the various uses by an image size detection unit;
changing the size of the image data stored in the image file acquired by the image acquisition unit to the size detected by the image size detection unit by a size change unit; and
uploading the image file in which the image data the size of which is changed by the size changing unit is stored to a server by a sending unit.

9. The method according to claim 8, further comprising:
copying the image file acquired by the image acquisition unit by a copying unit, wherein
the size change unit changes the size of the image data stored in the image file copied by the copying unit to the size detected by the image size detection unit.

10. The method according to claim 9, further comprising:
changing the name of the image file copied by the copying unit to a name corresponding to the use selected by the use reception unit by a file name change unit.
